(19) United States
(12) Patent Application Publication
(10) Pub. No.: US 2021/0180514 A1
(43) Pub. Date: Jun. 17, 2021

(54) JET ENGINE AIR INLET ARRANGEMENT AND METHOD FOR MANUFACTURE THEREOF

(71) Applicant: Rolls-Royce Deutschland Ltd & Co KG, Blankenfelde-Mahlow (DE)

(72) Inventor: Predrag TODOROVIC, Berlin (DE)

(21) Appl. No.: 16/710,792

(22) Filed: Dec. 11, 2019

(51) Int. Cl. F02C 7/047; F02C 7/045

(52) U.S. Cl. CPC F02C 7/047; B64D 33/02; F02C 7/045

(57) ABSTRACT

There is provided a jet engine air inlet arrangement having a front annular casing arrangement and a heating pipe arrangement. The heating pipe arrangement is supported onto an annular internal bulkhead, wherein the annular internal bulkhead provides a back wall to the cavity. The annular internal bulkhead is fabricated from deformed metal sheet, and includes a plurality of radially disposed stiffening projections and recesses in the back wall, and wherein the annular internal bulkhead includes inner and outer circumferential flanges that engage onto inside surfaces of the front annular casing arrangement behind the back wall. The plurality of radially disposed stiffening projections and recesses result in the flanges being disposed at a distance of more than 60 mm behind the plurality of radially disposed stiffening projections and recesses.

### TECHNICAL FIELD

The present disclosure relates generally to jet engines; more specifically, the present disclosure relates jet engine air inlet arrangements that peripherally surround air inlets of jet engines. Moreover, the present disclosure relates to methods for (namely, method of) manufacturing jet engine air inlet arrangements.

### BACKGROUND

Contemporary jet engines include de-icing systems. Ice formation on leading edges or surfaces of a given aircraft occurs when the given aircraft is flying at a high altitude, for example at an altitude of about 10 km or above, particularly when water droplets or ice particles at sub-zero temperature contact the leading edges or surfaces. Thus, ice formation may occur even below an altitude of about 10 km if there are conditions containing sub-zero temperatures and water droplet in the ambient air paired with sub-zero temperatures of aircraft or engine surfaces.

To perform a de-icing function, a given contemporary jet engines utilizes a de-icing arrangement, that forms a part of a jet engine air inlet arrangement that peripherally surrounds an air inlet of the given jet engine. The jet engine air inlet arrangement comprises an annular casing arrangement (such as a nose cowl) and a forward bulkhead. Furthermore, the anti-icing system primarily includes a tube arrangement for providing a flow of hot air, which enables the leading edges or surfaces to be de-iced. The tube arrangement is enclosed by the annular casing arrangement and supported on the forward bulkhead. Conventional jet engine air inlet arrangements suffer from various problem; for example, conventional jet engine inlet arrangements are too heavy that affects a functional efficiency of the given jet engine. Efficient de-icing of the annular casing arrangement is another problem, in which heat energy from the tube arrangement is expected to reach all nooks and corners of the annular casing arrangement to provide efficient de-icing.

Therefore, to ameliorate the technical problems encountered with known jet engine air inlet arrangements, there exists a need to provide an improved jet engine air inlet arrangement that is more effective when in operation and weighs less.

### SUMMARY

The present disclosure seeks to provide an improved jet engine air inlet arrangement. The present disclosure also seeks to provide an improved method for manufacturing a jet engine air inlet arrangement. The present disclosure seeks to provide a solution to the existing problem of a weight of a jet engine air inlet arrangement being too big, and to the existing problem of inefficient de-icing provided by a conventional jet engine air inlet arrangement when in operation. An aim of the present disclosure is to provide a solution that overcomes, at least partially, the aforementioned problems encountered in prior art, and to provide a jet engine air inlet arrangement which is of lower weight, more efficient in de-icing and provides a higher structural rigidity.

In one aspect, the present disclosure provides a jet engine air inlet arrangement that peripherally surrounds an air inlet of a jet engine, wherein:
the jet engine air inlet arrangement includes a front annular casing arrangement and a heating pipe arrangement disposed within a cavity provided within the front annular casing arrangement,
the heating pipe arrangement provides heating to the jet engine air inlet arrangement when in use,
the heating pipe arrangement is supported onto an annular internal bulkhead, wherein the annular internal bulkhead provides a back wall to the cavity;
the annular internal bulkhead is fabricated from deformed metal sheet, and includes a plurality of radially disposed stiffening projections and recesses in the back wall, and
the annular internal bulkhead includes inner and outer circumferential flanges that engage onto inside surfaces of the front annular casing arrangement behind the back wall, wherein a plurality of radially disposed stiffening projections and recesses result in the flanges being disposed at a distance of more than 60 mm behind the plurality of radially disposed stiffening projections and recesses.

The fabrication from deformed metal sheet may comprise at least one chosen from a deep drawn method or a super-plastic forming method. Alternatively, the annular internal bulkhead may be fabricated using a 3D printing method. Embodiments comprise fabricating the metal sheet from steel, Aluminium, Aluminium alloy, Titanium or a Titanium alloy.

Optionally, the front annular casing arrangement is provided with a plurality of perforations in fluid communication with the cavity, wherein the perforations provide, when in use, at least one of: heating of an external surface of the front annular casing arrangement leading into the air inlet of the jet engine, engine noise reduction.

Optionally, the annular internal bulkhead is fabricated as a monolithic structure. Optionally, alternatively, the annular internal bulkhead is fabricated from a plurality of components that are mutually assembled together.

In another aspect, the present disclosure provides a method for manufacturing a jet engine air inlet arrangement that peripherally surrounds an air inlet of a jet engine, wherein the jet engine air inlet arrangement includes a front annular casing arrangement and a heating pipe arrangement disposed within a cavity provided within the front annular casing arrangement, wherein the heating pipe arrangement provides heating to the jet engine air inlet arrangement when in use,

wherein the method includes:
(i) arranging for the heating pipe arrangement to be supported onto an annular internal bulkhead that provides a back wall to the cavity;
(ii) arranging for the annular internal bulkhead to be fabricated from deformed metal sheet, and arranging for the annular internal bulkhead to include a plurality of radially disposed stiffening projections and recesses in the back wall, and arranging for the annular internal bulkhead to include inner and outer circumferential flanges behind the back wall that engage onto inside surfaces of the front annular casing arrangement, wherein the plurality of radially disposed stiffening projections and recesses result in the flanges being disposed at a distance of more than 60 mm behind the plurality of radially disposed stiffening projections and recesses.

The proposed solution is also applicable to swirl thermal anti ice systems. Swirl thermal anti ice systems also contain a heating pipe arrangement that ejects air into the cavity. In such systems the hot air is ejected from feed air tube at one position. An ejection opening of the air tube is oriented into the circumferential direction of the cavity such that ejected hot air has a circumferential component allowing the hot air to swirl through the cavity thereby heating the front annular casing arrangement.

Embodiments of the present disclosure substantially eliminate or at least partially address the aforementioned problems in the prior-art, and provide a jet engine air inlet arrangement having a flatter and longer front annular casing arrangement and a light weight and structurally rigid annular internal bulkhead (or an optimized forward bulkhead).

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic drawing of a jet engine, in accordance with an embodiment of the present disclosure;

FIG. 2 is a perspective view of an air inlet arrangement of the jet engine of FIG. 1, in accordance with an embodiment of the present disclosure;

FIG. 3 is an enlarged perspective view of a portion of the air inlet arrangement of FIG. 2, in accordance with an embodiment of the present disclosure;

FIG. 4 is an enlarged perspective view of a rear portion of the air inlet arrangement of FIG. 2, in accordance with an embodiment of the present disclosure;

FIG. 5 is a cross-sectional view of the air inlet arrangement of FIG. 2 along an axis A-A′, in accordance with an embodiment of the present disclosure; and

FIG. 6 is a schematic view of a portion of an air inlet arrangement, in accordance with another embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In overview, embodiments of the present disclosure are concerned with a jet engine air inlet arrangement (referred to herein as “an air inlet arrangement” for conciseness) that peripherally surrounds an air inlet of a jet engine. The embodiments of the present disclosure are also concerned with a method for manufacturing the jet engine air inlet arrangement. The air inlet arrangement, when in operation, performs a plurality of functions: providing an air flow into the jet engine, inhibiting ice-formation on leading surfaces thereof, providing structural integrity to the jet engine and serving as an aesthetically pleasing component for the jet engine. Additionally, from an aerodynamic performance standpoint, the air inlet arrangement has a shape and dimensions that allow the air inlet arrangement to take full advantage of surface laminar flow benefits.

As aforementioned, the present disclosure provides an air inlet arrangement that peripherally surrounds an air inlet of a jet engine. The air inlet arrangement comprises various components, such as a front annular casing arrangement, a heating pipe arrangement and an annular internal bulkhead. The front annular casing arrangement is configured to have a flatter and a longer structural configuration compared to a contemporary conventional front annular casing arrangement. The flatter and longer structural configuration of the front annular casing arrangement enables more efficient de-icing for a larger area thereof to be achieved in operation. Furthermore, the front annular internal bulkhead is fabricated from a deformed metal sheet, which enables a weight if the bulkhead to be reduces, and hence an overall weight of the air inlet arrangement to be correspondingly reduced. Moreover, the front annular internal bulkhead has a non-planer structure, such as a form of corrugated structure, to provide the annular internal bulkhead with increased structural rigidity in comparison to a conventional planer front annular internal bulkhead.

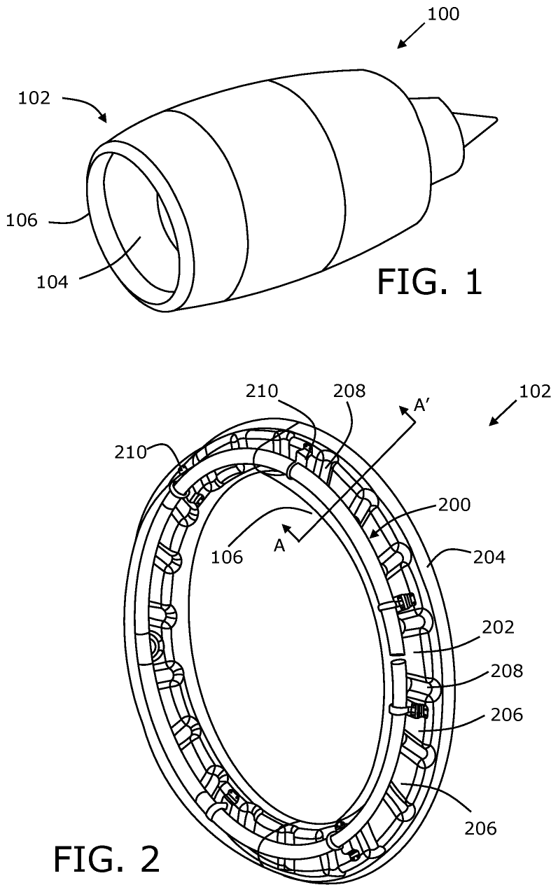

FIG. 1 is a schematic drawing of a jet engine 100, in accordance with an embodiment of the present disclosure. As shown, the jet engine 100 includes an air inlet arrangement 102 peripherally surrounding an air inlet 104 of the jet engine 100. The air inlet arrangement 102 is an annular arcuate structure that surrounds the air inlet 104. The air inlet arrangement 102 is operable to ensure a smooth airflow into the jet engine 100 through the air inlet 104. Typically, the air inlet arrangement 102 is configured to have a shape that accommodates variable air speeds and a wide variation of incident air-flow attack angles to ensure smooth airflow supply (i.e. a uniform constant air-flow) into the jet engine 100. The air inlet arrangement 102 includes a front annular casing arrangement 106 that acts as an outermost covering of the air inlet arrangement 102. The front annular casing arrangement 106 forms a lip for the air inlet 104.

Referring now to FIG. 2, there is illustrated a perspective view of the air inlet arrangement 102 of the jet engine 100 (shown in FIG. 1), in accordance with an embodiment of the present disclosure. As shown, the air inlet arrangement 102 includes a heating pipe arrangement 200 disposed within a cavity 202 provided within the front annular casing arrangement 106. Typically, the heating pipe arrangement 200 is placed along a circumference of the air inlet arrangement 102. As shown, the air inlet arrangement 102 also includes an annular internal bulkhead 204. The annular internal bulkhead 204 supports the heating pipe arrangement 200 thereon. The annular internal bulkhead 204 provides a back wall to the cavity 202. The annular internal bulkhead 204 includes a plurality of radially disposed stiffening projections, such as stiffening projections 206, and recesses, such as recesses 208, in the back wall.

As shown in FIG. 2, the annular internal bulkhead 204 is configured to support to the heating pipe arrangement 200 thereon using a plurality of stiffeners 210. The plurality of stiffeners 210 are placed at regular intervals along the annular internal bulkhead 204 for rigidly mounting the heating pipe arrangement 200 onto the annular internal bulkhead 204.

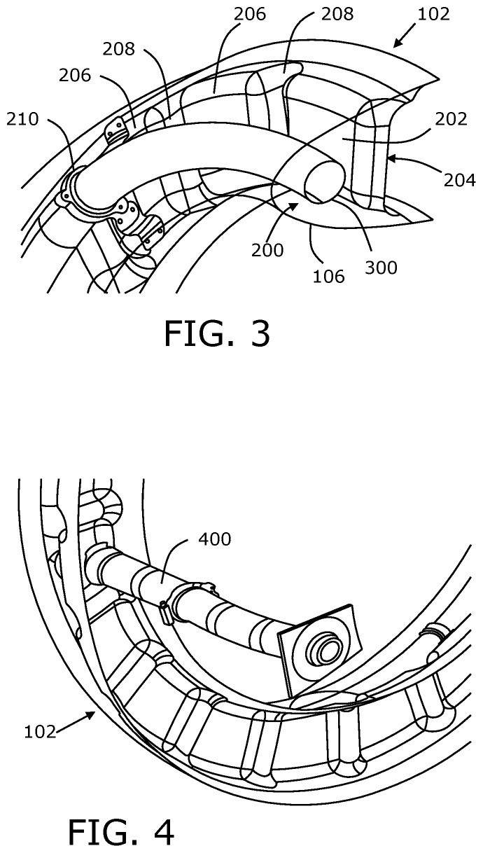

Referring now to FIG. 3, there is illustrated an enlarged perspective view of a portion of the air inlet arrangement 102 of FIG. 2, in accordance with an embodiment of the present disclosure. Specifically, in FIG. 3, there is illustrated a perspective cross-sectional view of a portion of the air inlet arrangement 102 of FIG. 2. As shown, the front annular casing arrangement 106 constitutes the outermost protective cover of the air inlet arrangement 102. According to an embodiment, the front annular casing arrangement 106 is configured to have an elliptical shape. Alternatively, optionally, the front annular casing arrangement 106 is configured to have triangular shape. The front annular casing arrangement 106 encompasses the heating pipe arrangement 200 and the annular internal bulkhead 204.

As shown, the heating pipe arrangement 200 includes a heating tube 300, particularly, a piccolo tube. In operation, the heating tube 300 functions to guide a flow of hot and high-pressure air therethrough for providing heat to the air inlet arrangement 102, primarily for de-icing the front annular casing arrangement 106. Typically, the flow of hot air is guided to be released from apertures (not shown) configured on the heating tube 300 for heating the front annular casing arrangement 106 and the annular internal bulkhead 204. As aforementioned, the annular internal bulkhead 204 provides (or forms) a back wall for the cavity 202; accordingly, the annular internal bulkhead 204 and the front annular casing arrangement 106 function to retaining the heat, provided by the heating pipe arrangement 200, substantially within the cavity 202.

The heating tube 300 is mounted on the annular internal bulkhead 204 using stiffeners, such as a stiffener 210. As shown, the stiffener 210 includes an annular recess (through which the heating tube 300 passes) and supporting tabs (configured to be mounted on the annular internal bulkhead 204). In particular, the supporting tabs of the stiffener 210 are configured to conform to a shape of the stiffening projection 206 for being mounted over the stiffening projection 206 using fasteners, such as screws, bolts or rivets. The stiffening projections 206 are shown to be separated or spaced apart by the recesses 208. These stiffening projections 206 and the recesses 208 are radially disposed along the annular internal bulkhead 204 as shown. The stiffening projections 206 provide more structural rigidity to the annular internal bulkhead 204 in comparison to a conventional planner annular internal bulkhead.

Referring to FIG. 4, there is illustrated an enlarged perspective view of a rear portion of the air inlet arrangement 102 of FIG. 2, in accordance with an embodiment of the present disclosure. Specifically, in FIG. 4, there is depicted a feed pipe 400 of the heating pipe arrangement 200, shown in FIG. 3. The feed pipe 400 is fluidically coupled to the heating tube 300 (shown in FIG. 3) and is arranged perpendicularly to the heating tube 300. The feed pipe 400 is operatively coupled to a hot air source for carrying the hot air from the hot air source and for delivering the hot air to the heating tube 300. Generally, the hot air source may be a combustor or a compressor of the jet engine 100 (shown in FIG. 1), depending upon a required temperature of the hot air. For example, the compressor is operable to compress the air entering into the jet engine 100 to a temperature in a range of 200 to 550° C., whereas the combustor exhaust air is capable of reaching a temperature of up to 2000° C.

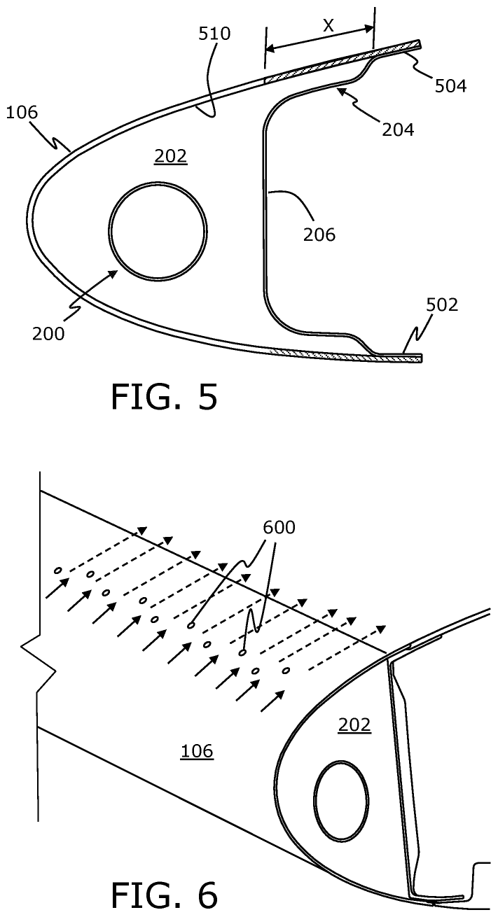

FIG. 5 is a cross-sectional view of the air inlet arrangement 102 of FIG. 2 along an axis A-A′, in accordance with an embodiment of the present disclosure. As depicted, the annular internal bulkhead 204 serves as the back wall to the cavity 202. The annular internal bulkhead 204 includes inner and outer circumferential flanges 502, 504 that engage onto an inside surface 510 of the front annular casing arrangement 106 behind the back wall (i.e. formed by the annular internal bulkhead 204). According to an embodiment, the inner and outer circumferential flanges 502, 504 of the annular internal bulkhead 204 are optionally snap-fitted with the inside surface 510 of the front annular casing arrangement 106. Alternatively, the inner and outer circumferential flanges 502, 504 are optionally coupled to the inside surface 510 using fasteners, such as screws, bolts or rivets. As shown, the plurality of radially disposed stiffening projections 206 and the recesses 208 (best shown in FIG. 3) result in the inner and outer circumferential flanges 502, 504 being disposed at a distance of more than 60 millimetre (mm), more optionally more than 65 mm, behind the plurality of radially disposed stiffening projections 206 and the recesses 208. Specifically, the front annular casing arrangement 106 of the present disclosure is configured to have a flatter configuration (as compared to a conventional front annular casing arrangement), therefore the annular internal bulkhead 204 is in aggregate arranged at a greater distance away from the heating pipe arrangement 200. In other words, the front annular casing arrangement 106 is configured to have an extended length “X” as compared to a length of the conventional front annular casing arrangement. In an example, as shown in FIG. 5, the extended length “X” corresponds to the depth of the radially disposed stiffening projections 206 and the recesses 208. Furthermore, the extended length “X” is optionally more than 60 mm, more optionally 65 mm, or may be 70 mm.

According to an embodiment, the extended length “X” of the front annular casing arrangement 106 provides an extra area for heating the air inlet arrangement 102. It will be apparent that the extra area requires extra heat input to be provided by the feed pipe 400 (shown in FIG. 4) to the heating pipe arrangement 200 to maintain a required rate of heating for de-icing the front annular casing arrangement 106.

In an example, a distance between a tip of the front annular casing arrangement 106 and the annular internal bulkhead 204 is about 197.2 mm, i.e. 65 mm longer than a conventional length (of about 154.8 mm) of a BR725 D-Duct. Such a greater distance results in in the extended length “X” (or extended portion) of the front annular casing arrangement 106. In order to compensate a gain in weight due to the extended length “X”, a width of the front annular casing arrangement 106 is reduced to a certain degree. In other words, the front annular casing arrangement 106 is made flatter and longer.

The annular internal bulkhead 204 is fabricated from deformed metal sheet. Optionally, the annular internal bulkhead 204 is fabricated from deep-drawn or super-plastic-deformed metal sheet. With superplastic forming, the metal sheet is inserted in a die cavity or a pressure chamber, and hot pressurized gas is applied evenly to deform the metal, whereas, for deep drawing a sheet metal blank is radially drawn into a forming die by the mechanical action of a punch.

More optionally, the metal sheet is fabricated from steel, Aluminium, an Aluminium alloy, Titanium or a Titanium alloy. According to an embodiment, typically, the annular internal bulkhead 204 has a weight of 18.394 kg. In this case, when the annular internal bulkhead 204 is made of Titanium sheet metal having a density of about 5410 kg/m³ and a thickness of about 1.2 mm, the annular internal bulkhead 204 has a weight of 9.382 kg, i.e. 49% less than the weight of 18.394 kg. Alternatively, when the annular internal bulkhead 204 is made of Titanium sheet metal having a density of about 5410 kg/m³ and thickness of about 1.6 mm, the annular internal bulkhead 204 has a weight of 12.509 kg, i.e. 32% less than the weight of 18.394 kg. It will be evident that the lower weight of the annular internal bulkhead 204 thereby achieved enables a functional efficiency of the jet engine 100 to be increased. Additionally, it will be apparent that the annular internal bulkhead 204 optionally has other structural and/or compositional values, for example the metal sheet optionally has a density in a range of 5300 kg/m³ to 5500 kg/m³, and optionally has a thickness in a range of 1 mm to 2 mm.

Optionally, the annular internal bulkhead 204 is fabricated as a monolithic structure. Alternatively, optionally, the annular internal bulkhead 204 is fabricated from a plurality of components that are mutually assembled together. For example, the annular internal bulkhead 204 is optionally either made of a single piece of sheet metal or four pieces of sheet metal that are assembled together.

More optionally, the front annular casing arrangement 106 and the annular internal bulkhead 204 are fabricated as a monolithic structure, Alternatively, optionally, the front annular casing arrangement 106 and the annular internal bulkhead 204 are fabricated as separate components that are assembled together.

FIG. 6 is a schematic view of a portion of an air inlet arrangement, such as the air inlet arrangement 102, in accordance with another embodiment of the present disclosure. As shown, the front annular casing arrangement 106 is provided with a plurality of perforations 600 in fluidic communication with the cavity 202. The perforations 600 are fabricated on at least an external surface of the front annular casing arrangement 106. In other words, the perforations 600 are provided peripherally around the front annular casing arrangement 106. The perforations 600 provide, when in use, heating of an external surface of the front annular casing arrangement 106 leading into the air inlet 104 (shown in FIG. 1) of the jet engine 100. Such heating melts ice particles that are susceptible to accumulating on external surface of the front annular casing arrangement 106, thereby keeping the external surface free of ice.

As shown, the incoming cold air depicted with solid arrows and the hot air coming out of the perforations 600 is shown with dotted arrows. The cold air mixes with the hot air but still a certain degree of heating is provided by the hot air over the front annular casing arrangement 106 for de-icing thereof. It will be apparent that the perforations 600 are an additional benefit of providing the extended length “X” of the front annular casing arrangement 106 for achieving efficient de-icing.

In an example, the perforations 600 are specially fabricated using special manufacturing techniques such as, but not limited to, electron beam machining and laser beam machining. The fabrication of the perforations 600 is implemented in a manner such that drag force generated from an entrained mass of air is sufficient to negate formation of ice on the perforations 600. Furthermore, the arrangement and configuration (shape and dimension) of the perforations 600 are selected in a manner so as to provide an effective uniform heating to the front annular casing arrangement 106 to inhibit ice-formation over the leading edges.

According to an embodiment, the perforations, when in use, also potentially enable a reduction in engine noise by causing acoustic radiation dissipation.

The present disclosure also relates to a method for manufacturing a jet engine air inlet arrangement that peripherally surrounds an air inlet of a jet engine, wherein the jet engine air inlet arrangement includes a front annular casing arrangement and a heating pipe arrangement disposed within a cavity provided within the front annular casing arrangement, and wherein the heating pipe arrangement provides heating to the jet engine air inlet arrangement when in use. The method comprises arranging for the heating pipe arrangement to be supported onto an annular internal bulkhead that provides a back wall to the cavity. The method also comprises arranging for the internal bulkhead to be fabricated from deformed metal sheet, and arranging for the internal bulkhead to include a plurality of radially disposed stiffening projections and recesses in the back wall, and arranging for the internal bulkhead to include inner and outer circumferential flanges behind the back wall that engage onto inside surfaces of the front annular casing arrangement, wherein the plurality of radially disposed stiffening projections and recesses result in the flanges being disposed at a distance of more than 60 mm behind the plurality of radially disposed stiffening projections and recesses.

It will be evident that the method relates to the manufacturing of the jet engine air inlet arrangement, such as the air inlet arrangement 102, that peripherally surrounds the air inlet, such as the air inlet 104, of the jet engine, such as the jet engine 100 (as shown in FIG. 1). Therefore, various embodiments and variants disclosed regarding the air inlet arrangement 102 above apply mutatis mutandis to the method.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A jet engine air inlet arrangement that peripherally surrounds an air inlet of a jet engine, wherein the jet engine air inlet arrangement includes a front annular casing arrangement and a heating pipe arrangement disposed within a cavity provided within the front annular casing arrangement, wherein the heating pipe arrangement provides heating to the jet engine air inlet arrangement when in use,
characterized in that
the heating pipe arrangement is supported onto an annular internal bulkhead, wherein the annular internal bulkhead provides a back wall to the cavity;
wherein the annular internal bulkhead is fabricated from deformed metal sheet, and includes a plurality of radially disposed stiffening projections and recesses in the back wall, and wherein the annular internal bulkhead includes inner and outer circumferential flanges that engage onto inside surfaces of the front annular casing arrangement behind the back wall, wherein the plurality of radially disposed stiffening projections and recesses result in the flanges being disposed at a distance of more than 60 mm behind the plurality of radially disposed stiffening projections and recesses.

2. The jet engine air inlet arrangement of claim 1, wherein the annular internal bulkhead is fabricated as deep-drawn or super-plastic-deformed metal sheet, or as 3D printed parts.

3. The jet engine air inlet arrangement of claim 2, wherein the metal sheet is fabricated from steel, Aluminium, an Aluminium alloy, Titanium or a Titanium alloy.

4. The jet engine air inlet arrangement of claim 1, wherein the front annular casing arrangement is provided with a plurality of perforations in fluidic communication with the cavity, wherein the perforations provide, when in use, at least one of: heating of an external surface of the front annular casing arrangement leading into the air inlet of the jet engine, engine noise reduction.

5. The jet engine air inlet arrangement of claim 1, wherein the annular internal bulkhead is fabricated as one of: a monolithic structure, a plurality of components that are mutually assembled together.

6. A method for manufacturing a jet engine air inlet arrangement that peripherally surrounds an air inlet of a jet engine, wherein the jet engine air inlet arrangement includes a front annular casing arrangement and a heating pipe arrangement disposed within a cavity provided within the front annular casing arrangement, wherein the heating pipe arrangement provides heating to the jet engine air inlet arrangement when in use,
characterized in that the method includes:
(i) arranging for the heating pipe arrangement to be supported onto an annular internal bulkhead that provides a back wall to the cavity;
(ii) arranging for the annular internal bulkhead to be fabricated from deformed metal sheet, and arranging for the annular internal bulkhead to include a plurality of radially disposed stiffening projections and recesses in the back wall, and arranging for the annular internal bulkhead to include inner and outer circumferential flanges behind the back wall that engage onto inside surfaces of the front annular casing arrangement, wherein the plurality of radially disposed stiffening projections and recesses result in the flanges being disposed at a distance of more than 60 mm behind the plurality of radially disposed stiffening projections and recesses.
